(19) United States
(12) Patent Application Publication
(10) Pub. No.: US 2017/0282796 A1
(43) Pub. Date: Oct. 5, 2017

(54) VEHICLE PERIPHERY MONITORING APPARATUS

(71) Applicant: Toshiba Alpine Automotive Technology Corporation, Iwaki-shi (JP)

(72) Inventor: Masanori KOSAKI, Iwaki-shi (JP)

(73) Assignee: Toshiba Alpine Automotive Technology Corporation, Iwaki-shi (JP)

(21) Appl. No.: 15/237,867

(22) Filed: Aug. 16, 2016

(30) Foreign Application Priority Data
Apr. 4, 2016 (JP) 2016-075033

(51) Int. Cl. B60R 1/00; G06F 3/01; G06K 9/00

(52) U.S. Cl. CPC B60R 1/00; G06K 9/00805; G06F 3/013; B60R 2300/30; B60R 2300/20; B60R 2300/8046

(57) ABSTRACT

According to one embodiment, a vehicle periphery monitoring apparatus comprises: an outside-view camera; a display; and an image processor. The image processor is to acquire information about the position of a driver's viewpoint, information about the position of the display, information about the position of a virtual mirror for geometrically transforming an image picked up by the outside-view camera to an image viewed from the viewpoint, and to generate a mirror-displaying image to be displayed on the virtual mirror, from the information about the position of the viewpoint, information about the position of the display, information about the position of the virtual mirror and the image picked up by the outside-view camera. The image processor generates data representing a mirror frame surrounding the mirror-displaying image, and causes the display to display the mirror frame and the mirror-displaying image in the mirror frame.

### CROSS-REFERENCE TO RELATED APPLICATIONS

This application is based upon and claims the benefit of priority from the prior Japanese Patent Application No. 2016-075033 filed on Apr. 4, 2016, the entire contents of which are incorporated herein by reference.

### FIELD

Embodiments describe herein relate generally to a vehicle periphery monitoring apparatus.

### BACKGROUND

An apparatus is known, which uses a camera instead of side-view mirrors, imaging the periphery of a vehicle and which shows the image of the periphery to the driver.

There have been proposed, for example, an apparatus comprising a camera positioned on the line extending between the display and the driver's eyes, and a vehicle periphery monitoring system designed to change the monitoring area in accordance with the position of the driver's head.

Also proposed is a display for use in vehicles, which can correct an image in accordance with the size and position of the display to show the size of the image displayed. Further, a display system has been proposed, which can change the magnification of a part of an image, to overcome the problem resulting from an obstacle.

However, neither the apparatus nor the system can display the distance between the vehicle and anything outside the vehicle, as the side-view mirrors do.

Even if the display enables the driver to figure out the distance as the side-view mirrors do, this depends on the position or orientation of the display. The display may display a magnified image, from which the driver can hardly perceive the actual distance or the positional relation between the vehicle and the object outside the vehicle.

### BRIEF DESCRIPTION OF THE DRAWINGS

FIG. 1 is a block diagram showing an exemplary configuration of a vehicle periphery monitoring apparatus, according to an embodiment of this invention;

FIG. 2 is a diagram showing the major components of the vehicle periphery monitoring apparatus;

FIG. 3 is a diagram explaining the positional relation the components assume in the vehicle periphery monitoring apparatus according to the embodiment;

FIG. 4 is a diagram showing lines explaining how light coming from a viewpoint is reflected by a virtual mirror;

FIG. 5 is a flowchart explaining how a mirror-frame image to be displayed is processed;

FIG. 6 is a diagram showing a modification using a graduated mirror frame;

FIG. 7 is a diagram showing a modification in which the lines showing the mirror frame are increased in thickness;

FIG. 8A and FIG. 8B are diagrams showing an embodiment in which the mirror frame is displayed in a warped form;

FIGS. 9A and 9B are diagrams showing an embodiment in which a frame representing a lens is displayed near the mirror frame;

FIGS. 10A and 10B are diagrams showing an embodiment in which a frame indicating the magnification is displayed near the mirror frame;

FIG. 11 is a diagram explaining a modification in which the position of the driver's eyes moves more than a threshold distance;

FIG. 12 is a diagram explaining a modification in which the display and the mirror-displaying surface are arranged in a specific relation;

FIG. 13 is a diagram explaining a modification in which the outside-view camera has been changed in position;

FIG. 14 is a diagram explaining a modification in which the virtual mirror has been changed in position;

FIG. 15 is a diagram explaining a modification in which mirror-frame images overlap each other;

FIG. 16 is a diagram explaining a modification in which the vehicle image is made transparent;

FIG. 17 is a diagram explaining a modification in which the driver may change the position or inclination of the mirror-frame image;

FIG. 18 is a diagram explaining a modification in which two or more outside-view cameras are secured to the vehicle; and

FIG. 19 is a diagram explaining another modification in which two or more outside-view cameras are secured to the vehicle.

### DETAILED DESCRIPTION

A vehicle periphery monitoring apparatus, according to one embodiment, comprises an outside-view camera, a display, an image processor. The outside-view camera images the periphery of the vehicle. The display shows the image of the periphery of the vehicle. The image processor acquires information about the position of the driver's viewpoint, information about the position of the display, and information about the position of a virtual mirror for geometrically transforming an image picked up by the outside-view camera, to an image viewed from the viewpoint. The image processor then generates an image viewed from the driver's viewpoint that should be displayed on the virtual mirror, based on the information about the position of the viewpoint, information about the position of the display and information about the position of a virtual mirror. Further, the image processor generates a mirror frame image surrounding the image of the mirror. The image processor causes the display to display the mirror frame and to display, in the mirror frame, the image viewed from the viewpoint.

An embodiment of this invention will be described with reference to the accompanying drawings.

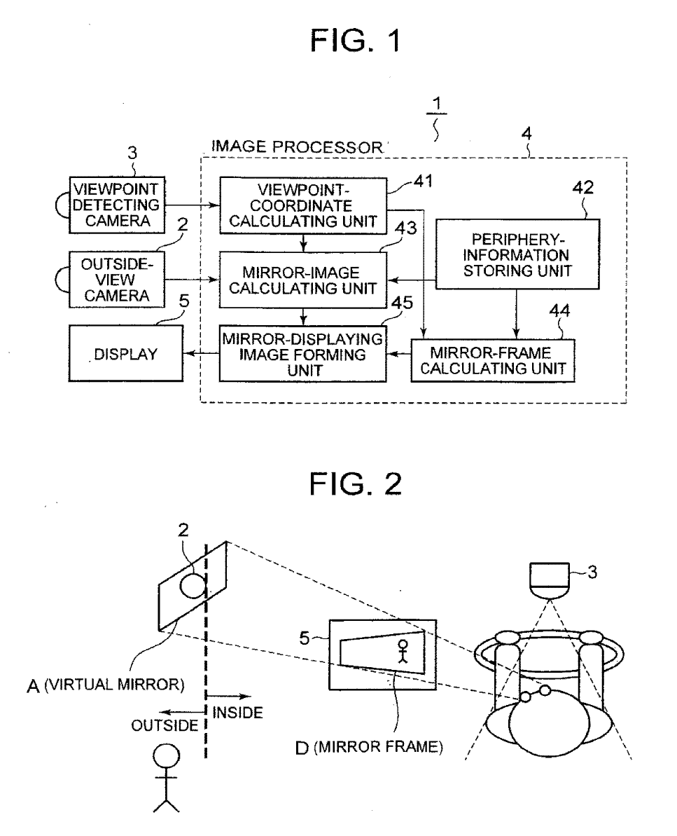

FIG. 1 shows an exemplary configuration of a vehicle periphery monitoring apparatus, according to the embodiment of the invention. As shown in FIG. 1, the vehicle periphery monitoring apparatus 1 roughly comprises an outside-view camera 2, a viewpoint detecting camera 3, an image processor 4, and a display 5. In this embodiment, the vehicle periphery monitoring apparatus 1 displays, on the display 5, an image acquired in the outside-view camera 2, as a mirror frame image specifying the three-dimensional position of the mirror frame. This enables the driver to see the periphery of the vehicle and grasp the distance between the vehicle and anything outside the vehicle, in the same way as he or she looks into actual mirrors (e.g., side-view mirrors).

The outside-view camera 2 images the periphery of the vehicle, and is attached to the vehicle.

The viewpoint detecting camera 3 is a camera for detecting a viewpoint of the driver of the vehicle, and images, for example, the driver's face including the driver's viewpoint. The viewpoint detecting camera 3 is arranged, opposing to the driver's seat. The viewpoint detecting camera 3 need not be used if the position of the driver in the driver's seat can be detected as default value and the driver's viewpoint can be approximately detected.

The image processor 4 forms an image to be displayed on the display 5. In this embodiment, a mirror-displaying image which will be displayed in a virtual mirror (later described) and which is surrounded by a mirror frame (later described). The image processor 4 may be constituted by, for example, a viewpoint-coordinate calculating unit 41, a periphery-information storing unit 42, a mirror-image calculating unit 43, a mirror-frame calculating unit 44, and a mirror-displaying image forming unit 45.

The viewpoint-coordinate calculating unit 41 calculates the coordinates of the driver's viewpoint from the image formed by the viewpoint detecting camera 3. The obtained data representing the coordinates of the driver's viewpoint is supplied to the mirror-image calculating unit 43.

The periphery-information storing unit 42 stores information representing the position and angle at which the outside-view camera 2 is attached to the vehicle, the information representing the position and angle at which the display 5 is attached, and information representing the position and angle at which the virtual mirror is arranged. The virtual mirror is an imaginary mirror that geometrically transforms an image picked up by the outside-view camera 2, to an image viewed from the viewpoint. The position and angle at which the virtual mirror is arranged can be set in consideration of the driver's viewpoint and the position and angle at which the display 5 is arranged.

The positions and angles at which the outside-view camera 2 and display 5 are arranged are limited to some extent by the type of the vehicle. They may therefore be preset as default values. The various information items stored in the periphery-information storing unit 42 are used in the mirror-image calculating unit 43 and mirror-frame calculating unit 44.

The mirror-image calculating unit 43 calculates a mirror image to be displayed on the virtual mirror, from the coordinate data about the viewpoint calculated by the viewpoint-coordinate calculating unit 41 and the position-angle data stored in the periphery-information storing unit 42. The information representing the mirror image thus obtained is supplied to the mirror-displaying image forming unit 45.

The mirror-frame calculating unit 44 calculates a mirror frame, from the viewpoint-coordinate data and the position-angle data stored in the periphery-information storing unit 42. The mirror frame so calculated surrounds the mirror image. From the mirror image displayed on the display 5, the driver can correctly grasp the distance, position and orientation of any object outside and near the vehicle.

The information about the mirror frame, acquired in the mirror-frame calculating unit 44, is supplied to the mirror-displaying image forming unit 45.

The mirror-displaying image forming unit 45 generates an image to display on the display 5, from the mirror-image information supplied from the mirror-image calculating unit 43 and the mirror-frame information supplied from the mirror-frame calculating unit 44. The mirror-displaying image generated is supplied to the display 5.

The display 5 receives the mirror-displaying image generated in the mirror-displaying image forming unit 45, and displays the mirror-displaying image.

FIG. 2 is a diagram showing the major components of the vehicle periphery monitoring apparatus 1 according to the embodiment of this invention. As shown in FIG. 2, a virtual mirror A is arranged at the position where the outside-view camera 2 is secured to the vehicle, and the outside-view camera 2 detects the angle at which the virtual mirror A reflects the light beam coming from the driver's viewpoint. Thus, the virtual mirror A geometrically transforms the image picked up by the outside-view camera 2 to an image viewed from the driver's viewpoint. The image including the mirror frame is displayed on the display 5. The driver of the vehicle can view the periphery of the vehicle, feeling the distance as if he or she is seeing the image in an actual mirror.

How the image processor 4 of the vehicle periphery monitoring apparatus 1 configured as described above operates will be described in detail.

### <Positional Relation of the Components>

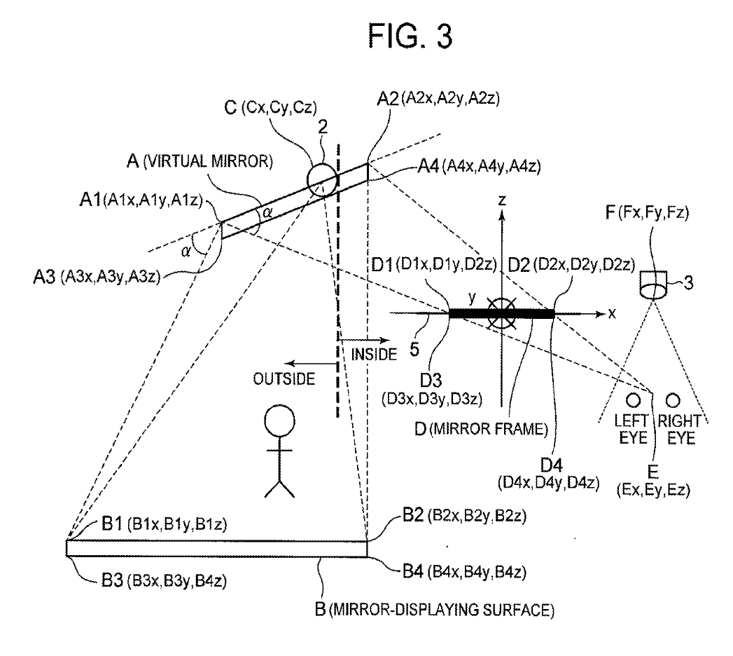

FIG. 3 is a diagram explaining the positional relation the components assume in the vehicle periphery monitoring apparatus 1 according to the embodiment. The positional relation of the components, shown in FIG. 3, is no more than an example. The positional relation is not limited to the relation of FIG. 3.

FIG. 3 shows the positional relation the components assume as the apparatus is viewed downwards. The coordinates indicating the position of the viewpoint detecting camera 3 are represented by F(Fx, Fy, Fz). The vehicle driver is seated, facing the viewpoint detecting camera 3, and the driver's viewpoint exists between his or her eyes. The coordinates indicating the position of the view point are E(Ex, Ey, Ez).

In the instance of FIG. 3, the outside-view camera 2 is arranged to photograph anything behind the vehicle. The position of the outside-view camera 2 is indicated by coordinates C(Cx, Cy, Cz).

The display 5 is arranged on the driver's line of sight. The physical center of the display 5 is located at the three-dimensional coordinates (x, y, z) shown in FIG. 3.

In the instance of FIG. 3, the virtual mirror A is arranged, assuming a specific positional relation with respect to the parts of the outside-view camera 2. The virtual mirror A is substantially rectangular, its apices A1, A2, A3 and A4 are positioned at coordinates A1(A1x, A1y, A1z), A2(A2x, A2y, A2z), A3(A3x, A3y, A3z) and A4(A4x, A4y, A4z), respectively.

In this embodiment, a mirror frame D specifying a three-dimensional position is displayed on the display 5 that displays the image picked up by the outside-view camera 2. Hence, the driver can view the periphery of the vehicle, feeling the distance as if he or she is seeing the image in an actual mirror (e.g., side-view mirror).

The coordinates representing the position of the mirror frame displayed on the display 5 are determined from the coordinates representing the positions of the apices A1, A2, A3 and A4 of the virtual mirror A and the coordinates representing the position of the driver's view point. How the coordinates of the mirror frame is determined will be described later in detail.

The shape of the mirror frame D is not limited to a substantial rectangle. The mirror frame D is displayed on the display 5, and is therefore smaller in size than the display 5. In the instance of FIG. 3, the mirror frame D is substantially rectangular, and the coordinates representing the positions of the apices D1, D2, D3 and D4 are: D1(D1x, D1y, D1z), D2(D2x, D2y, D2z), D3(D3x, D3y, D3z) and D4(D4x, D4y, D4z).

Moreover, in the instance of FIG. 3, a mirror-displaying surface B is arranged at a prescribed distance from the virtual mirror A, receiving light which emanates from the viewpoint and which the virtual mirror A reflects by angle α. It is desirable to determine the distance in accordance the ambient region which the outside-view camera 2 scans. If the distance is so determined, the three-dimensional position of the mirror-displaying surface B will be specified.

The substantially rectangular region extending from an end of the virtual mirror A to the other edge thereof, namely the region reflecting light and containing the apices A1, A2, A3 and A4, is defined as the region of the mirror-displaying surface B. In the instance of FIG. 3, the coordinates of points B1, B2, B3 and B4 defining the mirror-displaying surface B are represented by coordinates B1(B1x, B1y, B1z), B2(B2x, B2y, B2z), B3(B3x, B3y, B3z) and B4(B4x, B4y, B4z).

### <Calculation of the Coordinates Indicating the Position of Each Element>

How the coordinates indicating each element are calculated will be described in detail.

First, the viewpoint detecting camera 3 (i.e., camera F in FIG. 3) specifies the three-dimensional positions of the driver's left and right eyes, with respect to a viewpoint detecting camera F. The midpoint between the driver's eyes is associated with the center of the display 5 and set at coordinates E(Ex, Ey, Ez). It is desirable to set the viewpoint detecting camera F at an angle determined beforehand by using a measure or an angle-measuring device. The position of the viewpoint E detected by the viewpoint detecting camera F can therefore be converted to a position the viewpoint E takes with respect to the display 5.

The position of the viewpoint E may be predetermined with respect to the display 5 or may be shifted to some extent. In either case, the viewpoint detecting camera 3 (F) may not be used to determine the position of the viewpoint E takes with respect to the display 5, and the position data stored in a memory be used instead.

Next, the position of the virtual mirror A is set on a line extending from the viewpoint E to the display 5. If the driver intends to view an area right behind the vehicle (the rearward) for safety, the orientation of the virtual mirror A is determined to serve the driver's intension.

In this case, a point is selected on the virtual mirror A so that the coordinates of the point selected may exist at the back of the running vehicle.

Assume that the four corners of the virtual mirror A have apices A1, A2, A3 and A4. Then, a plane containing the apices A1(A1x, A1y, A1z) is expressed as follows if the normal vector is (Aa, Ab, Ac):

Aa·(x−A1x)+Ab·(y−A1y)+Ac·(z−A1z)=0

Similarly, the apices of the other corners of the virtual mirror A are calculated as A2, A3 and A4, by using the equation set forth above.

If the position of the apex A1, i.e., one of the apices of the virtual mirror A, is calculated, the straight line passing the viewpoint E and the virtual mirror A will be expressed as follows:

x=(Ex−A1x)·t+A1x

y=(Ey−A1y)·t+A1y

z=(Ez−A1z)·t+A1z,

where t is a parameter.

Assume that a perpendicular to the surface of the display 5 is set on the side opposite to the running direction of the vehicle (namely, if anything at the back of the vehicle is photographed). Then, z=0. Hence, the projected coordinate D1 that the apex A1 takes on the display 5 is t=A1z/(A1z−Ez).

A similar process is performed on the other apices A2, A3 and A4 of the virtual mirror A. Thus, the coordinates of the apices D1, D2, D3 and D4 of the mirror frame D displayed by the display 5 can be calculated and drawn.

An arrangement of the display 5 is being adjusted to a coordinate axis.

If the display 5 is set so as to be inclined, the equation for calculating its plane may be used to find the intersection of the plane and the above-mentioned straight line. If the inclination angle of the display 5 has been set for the type of the vehicle, the display 5 may be inclined by this angle. Otherwise, the display 5 is inclined by the angle determined by using a measure or an angle-measuring device.

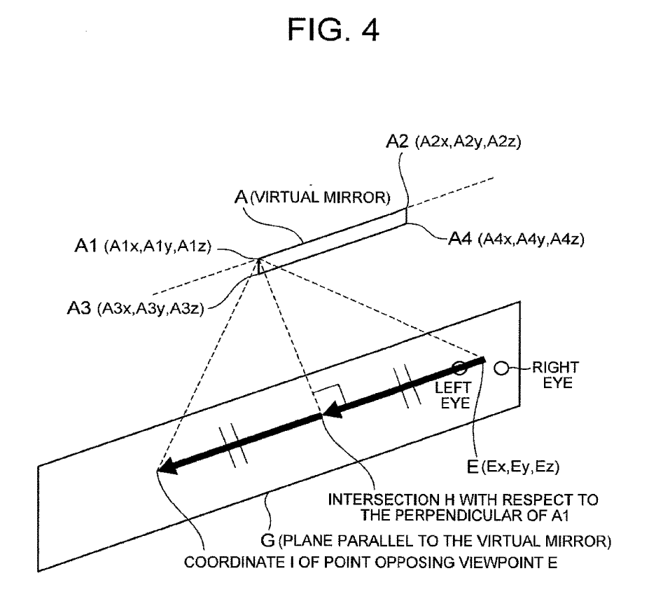

Then, the line in which the light propagates from the viewpoint E of the driver to the virtual mirror A and the line in which the light propagates after reflected by the virtual mirror A are calculated. FIG. 4 is a diagram showing these lines, showing how light coming from the viewpoint E is reflected by the virtual mirror A. As may be seen from FIG. 4, the plane G containing the viewpoint E and extending parallel to the surface of the virtual mirror A can be expressed by the following equation:

Aa·(x−Ex)+Ab·(y·Ey)+Ac·(z−Ez)=0,

where (Aa, Ab, Ac) is the normal vector of the plane G.

The straight line passing the apex A1 on the virtual mirror A and extending perpendicular to the virtual mirror A is given as follows:

x=Aa·t+A1x

y=Ab·t+A1y

z=Ac·t+A1z,

where t is a parameter.

The intersection H of this straight line and the plane G containing the viewpoint E and extending parallel to the surface of the virtual mirror A is then calculated. Around this intersection H(Hx, Hy, Hz), the coordinates I(Ix, Iy, Iz) are the coordinates to the point which the light reaches after reflected at the apex A1 on the virtual mirror A, as is viewed from the viewpoint E. The coordinates I are given by the following equations:

Ix=Hx+(Hx−Ex)

Iy=Hy+(Hy−Ey)

Iz=Hz+(Hz−Ez)

The straight line passing the point defined by these coordinates and the apex A1 of the virtual image A is the line in which the light reflected by the virtual mirror A propagates, as observed from the viewpoint E.

The direction of this line may be displayed on the display 5, as a direction in which the outside-view camera 2 scans. Further, a mirror-displaying surface B, i.e., the surface reflected by the virtual mirror A, may be prepared. In this case, the plane representing the mirror-displaying surface B is given as follows:

Ba·(x−Bx)+Bb·(y−By)+Bc·(z−Bz)=0,

where (Ba, Bb, Bc) is the normal vector of this plane, and (Bx, By, Bz) is the coordinates of one point on the mirror-displaying surface B.

In most cases, the mirror-displaying surface B is spaced from the outside-view camera 2 and is arranged perpendicular to the running direction of the vehicle. The point B1 is calculated, at which the mirror-displaying surface B intersects with the light reflected by the virtual mirror A as viewed from the viewpoint E. The coordinates of the point B1 are converted to the coordinates of a point seen from the outside-view camera 2. The coordinates of the point on the image picked up by the outside-view camera 2 are displayed on the display 5. The coordinates on the image, as viewed from the outside-view camera 2, can be calculated from the lens parameters and the outside-view camera parameters determined when the calibration is performed as the camera is attached.

In this embodiment, as described above, the image outside the vehicle is displayed on the display 5 via the virtual mirror while suppressing the driver's feeling of incompatibility with the distance and position. Thus, the driver of the vehicle can view the periphery of the vehicle, feeling the distance as if he or she is seeing the image in an actual mirror.

It will be described how the image of the mirror frame D is transformed before displayed on the display 5 in the vehicle periphery monitoring apparatus 1 so configured as described above.

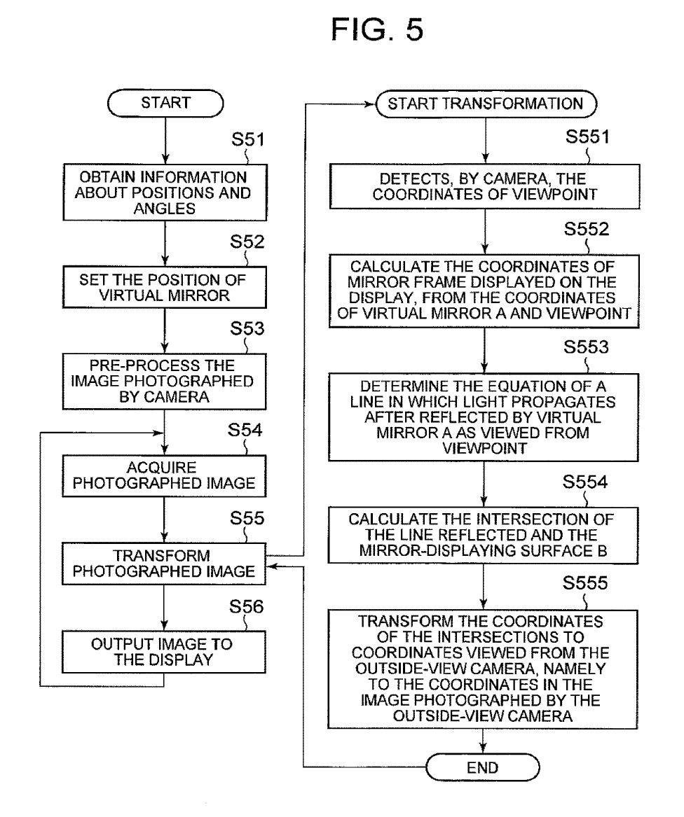

FIG. 5 is a flowchart explaining how a mirror-frame image is transformed before displayed on the display 5.

First, information about the positions and angles of the outside-view camera 2, virtual mirror A and display 5 are obtained from the periphery-information storing unit 42 (Step S51).

Next, the position of the virtual mirror A is set in three-dimensional coordinates (Step S52).

Then, the image picked up by the outside-view camera 2 is processed before it is transformed (Step S53). For example, a look-up table is generated for achieving the coordinate transformation when the outside-view camera 2 photographs an area right behind the vehicle (rearward area of the vehicle).

Next, a photographed image is acquired from the outside-view camera 2 (Step S54).

Then, the photographed image is transformed (Step S55).

In transforming the photographed image, the viewpoint detecting camera 3 detects the coordinates representing the position of the viewpoint E (Step S551).

Next, the coordinates representing the position of the mirror frame D displayed on the display 5 are calculated from the coordinates representing the position of the virtual mirror A and coordinates representing the position of the viewpoint E (Step S552).

Further, the equation of a straight line in which light propagates after reflected by the virtual mirror A as viewed from the viewpoint E is determined (Step S553).

The intersection of the line reflected and the mirror-displaying surface B is calculated (Step S554). All intersections calculated define the mirror-displaying surface B.

Then, the coordinates of the intersections are transformed to coordinates viewed from the outside-view camera 2, namely to the coordinates in the image formed on the outside-view camera 2 (Step S555). At this point, the transformation processing of the photographed image is terminated.

Next, the data representing the image so transformed is output to the display 5. The image displayed on the mirror is then displayed on the display 5 (Step S56).

### Modification 1 of the Embodiment

A modification of this embodiment will be described.

The location of the mirror-displaying surface B is being calculated prescribing the depth and when there is an object in the fixed distance, it looks natural.

But when the fixed distance is made quite big and it isn't calculated by the landscape which has no objects, it isn't indicated right.

If the above-mentioned prescribed distance is maximized (or set unlimitedly), the angle at which the light emanated from the viewpoint E is reflected by the virtual mirror A will be equal to the angle viewed from the outside-view camera 2. Therefore, the region displayed at this angle from the outside-view camera 2 may be displayed on the display 5. In this case, the display 5 may be inclined toward the user so that the user can easily see the image displayed on the display 5.

The position of the mirror-displaying surface B may be preset, and the virtual mirror A may then be positioned and inclined in accordance with the position preset. Further, the user may change the position and angle of the virtual mirror A.

### Modification 2 of the Embodiment

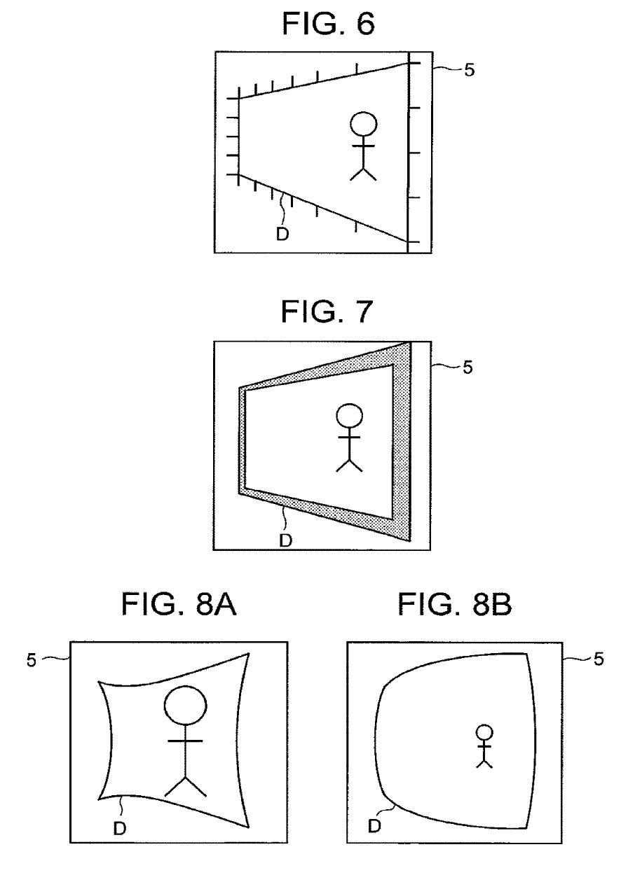

FIG. 6 is a diagram showing a modification using a graduated mirror frame D.

It is desirable to form, on the mirror frame D, a graduation, namely lines equally spaced from one another. The graduation helps the driver to grasp the distances better when he sees the image on the display 5. What kind of a gradation should be formed on the mirror frame D may be left to the driver's discretion.

### Modification 3 of the Embodiment

FIG. 7 is a diagram showing a modification in which the lines showing the mirror frame D are increased in thickness.

It is desirable to show the lines defining the mirror frame D in the same thickness and to change the mirror frame D in width, thereby to indicate clearly the direction in which the mirror frame D is inclined. In addition, the long sides of the mirror frame D and the short side thereof may be changed.

In modification 3, the inclination direction of the mirror can be grasped from the image of the mirror frame D.

### Modification 4 of the Embodiment

FIG. 8A and FIG. 8B are diagrams showing a modification in which the mirror frame D is displayed in a warped form. As shown in FIG. 8A, the mirror frame D is warped, each side bent concavely. Alternatively, as shown in FIG. 8B, the mirror frame D may be warped, each side bent convexly. In either case, the curvature may be changed as needed. Still alternatively, two or more mirror frames D may be provided, in which when the same direction is indicated in the different curved rate, near a too small object and far too big object, it is seen with the size tend to see in one of mirror frame D.

In Modification 4, the mirror frame D is warped. The driver can therefore recognize that the image shown in the mirror frame D is warped, and can understand that the image of the mirror frame D is magnified or contracted. Moreover, the driver can observe the mirror frame D and the image at the same time in various magnifications.

### Modification 5 of the Embodiment

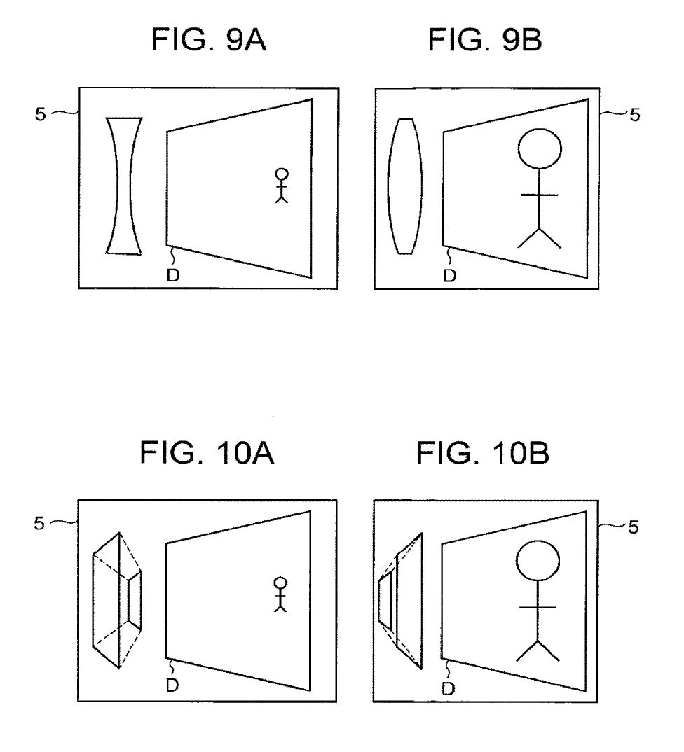

FIGS. 9A and 9B are diagrams showing a modification in which a frame representing a lens is displayed near the mirror frame D. FIGS. 10A and 10B are diagrams showing a modification in which a frame indicating the magnification is displayed near the mirror frame D.

It is desired that a frame representing a lens or a frame indicating the magnification should be displayed near the mirror frame D. The magnification displayed may be changed.

In Modification 5, even if the mirror frame D has a planer shape, a broad-range display or a narrow-range far-position display is performed, so that image magnification or contraction can be grasped.

### Modification 6 of the Embodiment

It is also desired that the display 5 should be a three-dimensional display. The display 5 can then display a stereoscopic image of the mirror frame D, and the driver can correctly perceive the depth of any object displayed.

In this case, the parts of the mirror frame D may be displayed in different colors, or figures may be drawn on the mirror frame D, which allows the driver to easily view the stereoscopic image. Further, a stereo-camera or mill-wave radar may be used to produce a three-dimensional map as viewed from the outside-view camera 2, the point at which the light emanating from the viewpoint and reflected by the virtual mirror A intersects with the three-dimensional map may be calculated, and the coordinates the point assumes in the image may be displayed, thereby to show correctly the position the point assumes in the image. In this case, the image may be generated from the images the driver sees with the left and right eyes.

In Modification 6, the position of the actual mirror can be determined from the position of the mirror frame D. The position of the image reflected can be determined, too.

### Modification 7 of the Embodiment

The position of the driver's eyes may be detected in real time. The image of the mirror frame D may then be displayed, at a correct distance, in accordance with the position detected.

In Modification 7, the position of the actual mirror can be correctly determined from the position of the mirror frame D.

### Modification 8 of the Embodiment

When indicating the way to the road which intersects on the T-intersection, mirror frame D was the same inclination, and a vehicle moved forward, the way to the road which intersects isn't shown to mirror frame D any more.

So the inclination of mirror frame D is changed, and the way to the road which always intersects is indicated. For example, the position of the driver's eyes may be detected in real time, thereby to display a mirror-displaying image oriented in a prescribed direction. In this case, the image of the mirror frame D may be inclined up or down, or to the left or the right, to indicate the same territory (the location).

In Modification 8, if the inclination of the image of the mirror frame D changes, it is determined that the mirror-displaying region remains unchanged.

### Modification 9 of the Embodiment

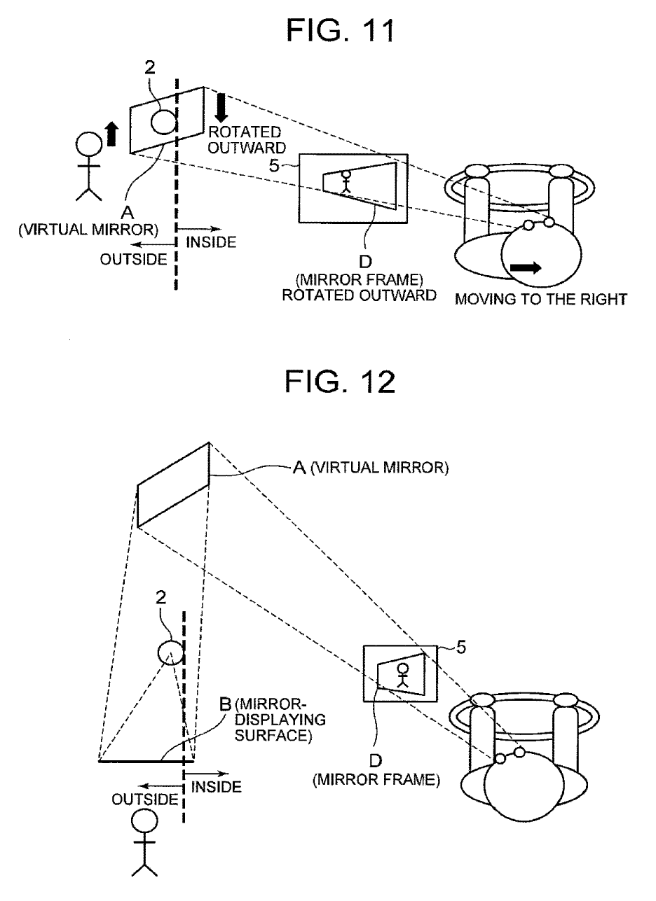

FIG. 11 is a diagram explaining a modification in which the position of the driver's eyes moves more than a threshold distance.

The driver, by shifting the positions of the eyes in the right and left, to see whether there is danger in the region to be viewed by shifting the region to be reflected in the mirror (there are no objects or not come object approaching).

Assume that the position of the driver's eyes is detected in real time and moved to the left or right, much more than a prescribed threshold value. Then, the territory (the location) may be easily displayed, in which the mirror frame D must be inclined to enable the driver to see any desired object on the mirror. If the position of the driver's eyes moves less than the threshold value, the inclination of the mirror will not be changed.

Modification 9 enables the driver to see anything outside the mirror, merely by moving him or herself a little, and can have a broad view field.

### Modification 10 of the Embodiment

FIG. 12 is a diagram explaining a modification in which the display 5 and the mirror-displaying surface B are arranged in a specific relation.

For when the angle to see the outside of the object does not see as much as possible from the same direction distortion of the image is large, and in as much as possible the same angle as viewed from the reflected angle and the outside of the outside-view camera 2 from the line of sight.

It is desired that the virtual mirror A should be arranged in a line extending from the display 5 and that the outside-view camera 2 should be arranged on the territory coming from the viewpoint and reflected by the virtual mirror A. In this case, the mirror-displaying surface is positioned from the virtual mirror A as far as possible. Alternatively, the mirror-displaying surface may be positioned unlimitedly far from the virtual mirror A and the angle of reflection angle and viewpoint position viewed from the outside-view camera 2 in a virtual mirror A may be displayed in the same.

In Modification 10, the display 5 can be arranged near the driver, and the motion of the driver's line of sight can be reduced. This helps to lessen the angle shift of the image displayed, and the strangeness the driver feels about the angle shift of the image displayed can be reduced.

### Modification 11 of the Embodiment

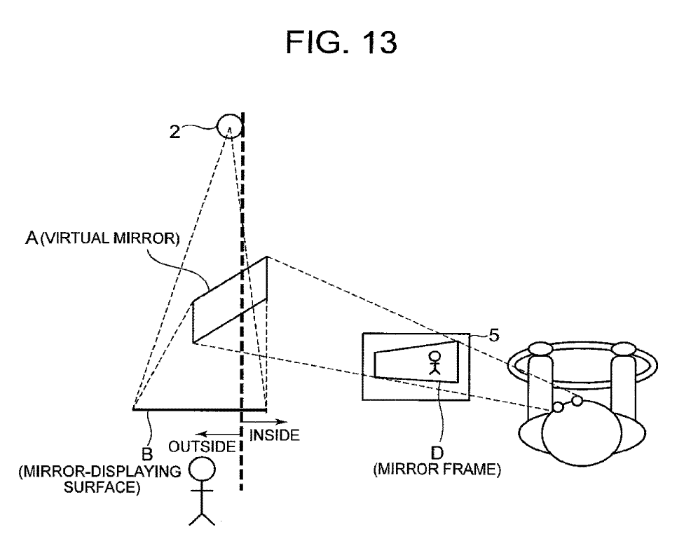

FIG. 13 is a diagram explaining a modification in which the outside-view camera 2 has been changed in position.

The virtual mirror A may be arranged on a light extending from the display 5, and the outside-view camera 2 may be arranged in a line extending from the viewpoint in the direction opposite to the direction in which the virtual mirror A reflects any light beam coming from the viewpoint. In this case, the mirror-displaying surface B may be positioned as far as possible, or may be arranged unlimitedly far, and the angle at which the virtual mirror A reflects a light beam is set equal to the angle at which the light beam has come from the outside-view camera 2, thereby to display the image.

In Modification 11, the virtual mirror A can be displayed both outside and inside the vehicle. Further, Modification 11 can reduce the strangeness the driver feels about the angle shift of the image displayed.

### Modification 12 of the Embodiment

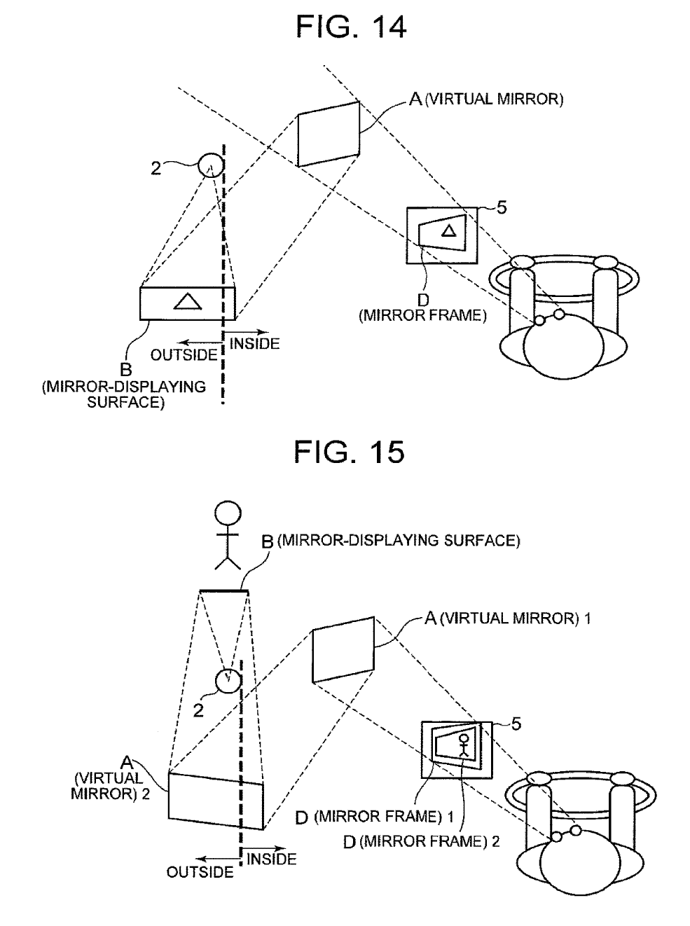

FIG. 14 is a diagram explaining a modification in which the virtual mirror A has been changed in position. In FIG. 14, the triangle mark indicates an example of a traffic sign drawn on the road. As shown in FIG. 14, the virtual mirror A may be positioned not on a line extending from the outside-view camera 2, but at a specific distance from the mirror-displaying surface B, and may be inclined to be able to display the position, and convert and display the image picked up by the outside-view camera 2. The outside-view camera 2 comprises, for example, a fish-eye lens in Modification 12.

In Modification 12, the display 5 can be so positioned that the driver can see an intended region while keeping the display 5 fixed in a position easy to see. Since the driver feels incompatible with a large region or a remote region, the display 5 shows the ground (e.g., road surface) whose distance is known.

### Modification 13 of the Embodiment

Two outside-view cameras 2 or a depth sensor may be attached to the vehicle to determine three-dimensional coordinates of a stereoscopic image, the position of this image may be corrected, and the image so corrected may be displayed on a mirror. In this case, the positions of the driver's left and right eyes may be determined and displayed, as mirror images, on a 3D display. Instead of two outside-view cameras 2, one outside-view camera 2 and a depth sensor may be used.

In Modification 13, even if the outside-view camera 2 is not positioned at the virtual mirror A or if the virtual mirror A is not positioned on a line extending from the outside-view camera 2, the sense of distance can be more correctly represented, irrespective of the mirror-displaying surface B.

### Modification 14 of the Embodiment

FIG. 15 is a diagram explaining a modification in which mirror-frame images overlap each other. As seen from FIG. 15, a mirror-frame image may be displayed in another mirror-frame image in an overlapped manner. A photographed image is displayed in the mirror-frame image, and another photographed image is displayed in the mirror-frame image overlapping the first mirror-frame image. In this case, the mirror-frame image overlapping the other mirror-frame image may be displayed a little above the other mirror-frame image.

Modification 14 can display an image not inverted in the left-right direction or in the up-down direction. Moreover, various parts can be viewed from one image displayed.

### Modification 15 of the Embodiment

The virtual mirror A is arranged in front of the driver, allowing upward reflection, and another virtual mirror A is arranged right above the driver, allowing downward reflection. The other virtual mirror A reflects an image downwards, accomplishing a top-view display.

In Modification 15, the top view can be displayed on the mirror.

### Modification 16 of the Embodiment

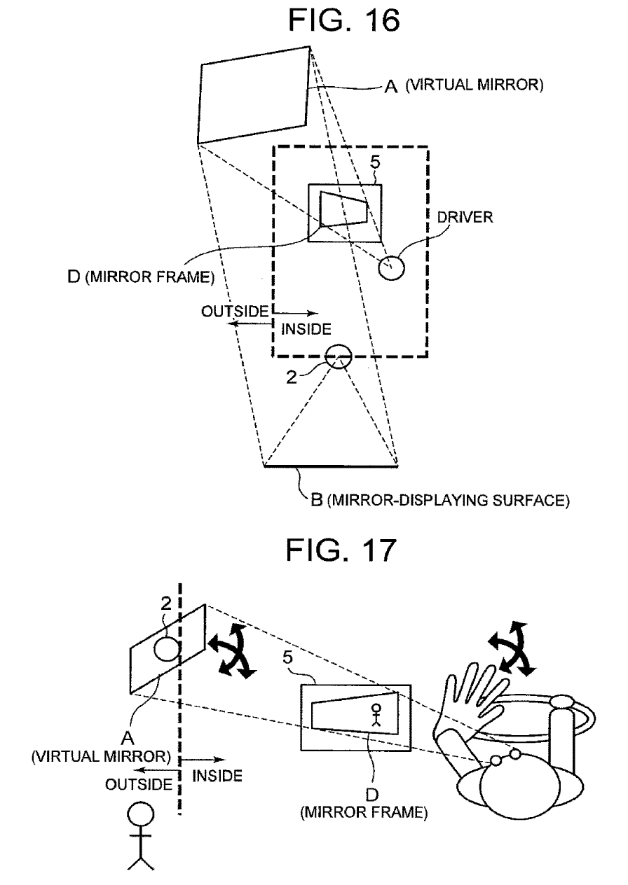

FIG. 16 is a diagram explaining a modification in which the vehicle image is made transparent. As shown in FIG. 16, the vehicle exists on a line extending from an image representing a mirror frame. In this case, an outside-view camera 2 is secured to the rear of the vehicle, thereby to render the vehicle image transparent. Further, vehicle information prepared may be used to make the vehicle image semi-transparent.

Hence, in Modification 16, something at the dead corner can also be displayed.

### Modification 17 of the Embodiment

The display 5 may be provided on an instrument panel fit in the dashboard lying in front of the driver. Alternatively, the display 5 may be a head-up display (HUD) or a head-mount display for use in vehicles.

In Modification 17, the driver can see, at the same time, the image displayed in the mirror frame and a real view outside the vehicle.

### Modification 18 of the Embodiment

FIG. 17 is a diagram explaining a modification 18 in which the driver may change the position or inclination of the mirror-frame image D. As shown in FIG. 17, the mirror-frame image D is changed in position and inclination, by manually operating a switch (no shown). As the switch is so operated, the image picked up by the camera is also displayed. The orientation of the mirror may be changed in accordance with the orientation of the driver's palm. Further, the image is magnified as the driver moves the thumb and the index finger away from each other, or is contracted if he moves the thumb and the index finger toward each other. The right-side mirror may be changed in orientation as the driver turns the right hand, and left-side mirror may be changed in orientation as the driver turns the left hand.

Thus, Modification 18 enables the driver to change the size and orientation of the mirror frame D very easily.

### Modification 19 of the Embodiment

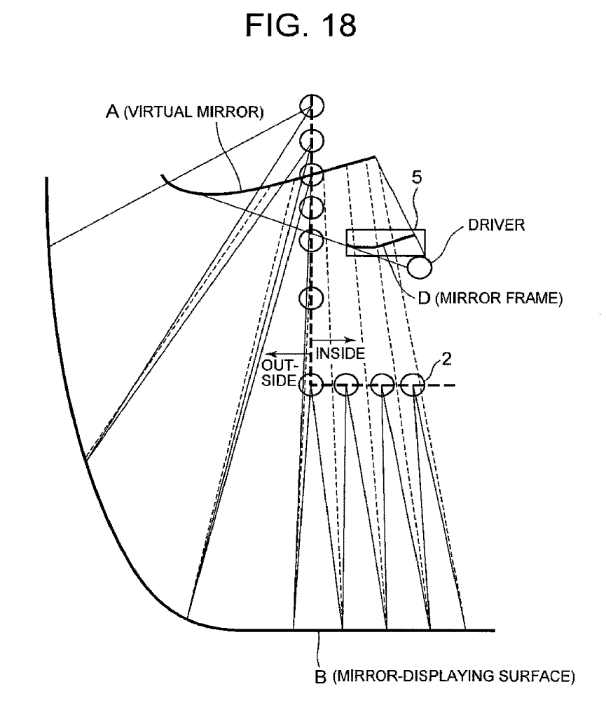

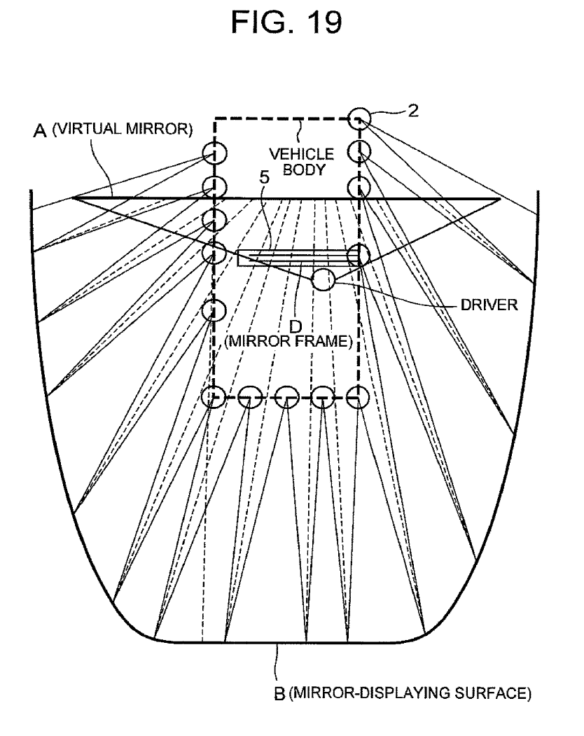

FIG. 18 and FIG. 19 show two examples in which two or more outside-view cameras 2 are secured to the vehicle. As shown in FIG. 18, a plurality of outside-view cameras 2 may be attached to the vehicle, and a plurality of photographed images may be displayed in accordance with the positional relations the images displayed on the mirrors have with the viewpoint E, thereby to display a stereoscopic image. In that case, stereoscopic images may be displayed by changing the scopes of the photographed images of the outside-view cameras 2 caught by each of the eyes.

In this case, the virtual image may be arranged as far as possible. Alternatively, the virtual image may be positioned unlimitedly far so that the angle by which the position of the viewpoint E is reflected by the virtual image A may be equal to the angle of the outside-view camera 2 arranged on a line extending from the viewpoint E. Any two adjacent outside-view cameras 2 may be coupled at the angle positions that are the midpoints on the lines extending from the outside-view cameras 2, respectively. Further, the two outside-view cameras 2 may be smoothly jointed to form a single image, by retrieving the characterizing points. Still further, the parts of the two outside-view cameras 2, at which they are jointed, may be a-blended and overlapped. Moreover, the outside-view cameras 2 may perform a stereoscopic photographing to display a corrected image of any object outside the vehicle at the real position of the object.

As shown in FIG. FIG. 19, a plurality of outside-view cameras 2 are attached to the vehicle so as to surround the vehicle. In this case, the mirror frame D is elongated, and the outside-view cameras 2 are switched from one to another, and the images photographed are displayed, one after another. If the outside-view cameras 2 are arranged in the height direction of the vehicle, the height of the mirror frame D may be proportionally increased, and the outside-view cameras 2 may be switched from one to another, to display photographed images one after another. In case that any outside-view camera 2 is broken, the image picked up by an adjacent outside-view camera 2 may be used.

Modification 19 can therefore correctly show the distance between the vehicle and the object picked up by any outside-view camera 2. A broad range can be viewed in a single mirror-displaying image.

### Modification 20 of the Embodiment

A wide-screen display 5 is used, mirror images to be displayed in regions on the display 5 and the orientation of each mirror image are preset. Any mirror image may be displayed when the line of sight moves to the display region showing the mirror image.

In Modification 20, the display 5 does not present unnecessary images, and the driver need not be bothered with the unnecessary images. Further, the driver can change the direction he or she desires to see merely by shifting the line of sight.

### Modification 21 of the Embodiment

Images may be displayed or not displayed, or a specific area or obstacle may be tracked and displayed, on the basis of navigation information, information about the vehicle and any obstacle recognized outside the vehicle. To tack the specific area or obstacle, it suffices to change the position or angle of the virtual mirror A.

In Modification 21, any image unnecessary is never displayed to annoy the driver. Further, even if the vehicle moves at an intersection, the display 5 can keep showing the directions of the crossing roads. Moreover, the display 5 can keep showing dangerous obstacles.

While certain embodiments have been described, these embodiments have been presented by way of example only, and are not intended to limit the scope of the inventions. Indeed, the novel methods and systems described herein may be embodied in a variety of the other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A vehicle periphery monitoring apparatus, comprising:
an outside-view camera to photograph the periphery of the vehicle;
a display to display images; and
an image processor to acquire information about the position of a driver's viewpoint, information about the position of the display, information about the position of a virtual mirror for geometrically transforming an image picked up by the outside-view camera to an image viewed from the viewpoint, and to generate a mirror-displaying image viewed form the viewpoint and to be displayed on the virtual mirror, from the information about the position of the viewpoint, information about the position of the display, information about the position of the virtual mirror and the image picked up by the outside-view camera,
wherein the image processor generates data representing a mirror frame surrounding the mirror-displaying image, and causes the display to display the mirror frame and the mirror-displaying image in the mirror frame.

2. The apparatus according to claim 1, further comprising a viewpoint detecting camera to provide a photograph of the driver's face, including the driver's line of sight.

3. The apparatus according to claim 1, wherein the image processor sets, at a prescribed distance from the virtual mirror, a mirror-displaying surface for reflecting light to the virtual mirror at the same angle as viewed from the driver's viewpoint, the mirror-displaying surface being a display region that reflects light beams reflected at the apices of the virtual mirror; and an image representing the three-dimensional position of the mirror-displaying surface specified by the outside-view camera is generated as a mirror-displaying image to be displayed on the virtual mirror.

4. The apparatus according to claim 2, wherein the image processor sets, at a prescribed distance from the virtual mirror, a mirror-displaying surface for reflecting light to the virtual mirror at the same angle as viewed from the driver's viewpoint, the mirror-displaying surface being a display region that reflects light beams reflected at the apices of the virtual mirror; and an image representing the three-dimensional position of the mirror-displaying surface specified by the outside-view camera is generated as a mirror-displaying image to be displayed on the virtual mirror.

5. The apparatus according to claim 4, wherein the position of the mirror frame to be displayed on the display is calculated from the coordinate information about the virtual mirror and the coordinate information about the viewpoint; a formula of a straight line reflected by the virtual mirror used as a mirror as viewed from the viewpoint is calculated; all intersections of the straight line and the mirror-displaying surface are calculated; the coordinates of the intersections are transformed to coordinates on the image picked up by the outside-view camera; and the image subjected to the transforming is displayed.

6. The apparatus according to claim 2, wherein the image processor comprise:
a viewpoint-coordinate calculating unit to acquire an image from the viewpoint detecting camera and to calculate the coordinates of the driver's viewpoint;
a periphery-information storing unit to store information representing the position and angle at which the outside-view camera is attached to the vehicle, information representing the position and angle at which the display is attached, and information representing the position and angle at which the virtual mirror is arranged;
a mirror-image calculating unit to calculate the mirror image from coordinate data about the viewpoint and the position-angle data stored in the periphery-information storing unit;
a mirror-frame calculating unit to calculate the mirror frame, from the viewpoint-coordinate data and the position-angle data stored in the periphery-information storing unit; and
a mirror-displaying image forming unit to generate an image to display on the virtual mirror, from the mirror-image information and the mirror-frame information.

7. The apparatus according to claim 1, wherein the virtual mirror is positioned on a line extending from the viewpoint, and the virtual mirror is orientated to set the mirror-displaying image in a prescribed direction.

8. The apparatus according to claim 1, wherein the image displayed on the display has a graduated mirror frame.

9. The apparatus according to claim 1, wherein the image displayed on the display has a thick mirror frame.

10. The apparatus according to claim 1, wherein the image displayed on the display has a warped mirror frame.

11. The apparatus according to claim 1, wherein the image displayed on the display has, near the mirror frame, a symbol indicating magnification.

12. The apparatus according to claim 1, wherein the virtual mirror is orientated to track a specific area or a specific object.
